(19) United States
(12) Patent Application Publication
(10) Pub. No.: US 2002/0171047 A1
(43) Pub. Date: Nov. 21, 2002

(54) Integrated laser diode array and applications

(76) Inventors: Kin Foeng Chan, Plano, TX (US); Wenhui Mei, Plano, TX (US); Jinhui Zhai, Plano, TX (US); Akira Ishikawa, Royse City, TX (US)

Correspondence Address: HAYNES AND BOONE, LLP, 901 MAIN STREET, SUITE 3100, DALLAS, TX, 75202, US

(21) Appl. No.: 09/820,030

(22) Filed: Mar. 28, 2001

(51) Int. Cl. G21G 5/00

(52) U.S. Cl. 250/492.1

(57) ABSTRACT

A system for performing digital lithography onto a subject is provided. The system includes a laser diode or LED array for generating and projecting a digital pattern. The array has a plurality of lasers which may be controlled either individually or as a group to produce the desired pattern. A lens system may then direct the digital pattern to the subject, thereby enabling the lithography.

### BACKGROUND

The present invention relates generally to lithographic exposure equipment, and more particularly, to a photolithography system and method, such as can be used in the manufacture of semiconductor integrated circuit devices.

In conventional analog photolithography systems, the photographic equipment requires a mask for printing an image onto a subject. The subject may include, for example, a photo resist coated semiconductor substrate for manufacture of integrated circuits, metal substrate for etched lead frame manufacture, conductive plate for printed circuit board manufacture, or the like. A patterned mask or photomask may include, for example, a plurality of lines or structures. During a photolithographic exposure, the subject must be aligned to the mask very accurately using some form of mechanical control and sophisticated alignment mechanism.

U.S. Pat. No. 5,691,541, which is hereby incorporated by reference, describes a digital, reticle-free photolithography system. The digital system employs a pulsed or strobed excimer laser to reflect light off a programmable digital mirror device (DMD) for projecting a component image (e.g., a metal line) onto a substrate. The substrate is mounted on a stage that moves during the sequence of pulses.

U.S. patent Ser. No. 09/480,796, filed Jan. 10, 2000 and hereby incorporated by reference, discloses another digital photolithography system which projects a moving digital pixel pattern onto specific sites of a subject. A “site” may represent a predefined area of the subject that is scanned by the photolithography system with a single pixel element.

Both digital photolithography systems project a pixel-mask pattern onto a subject such as a wafer, printed circuit board, or other medium. The systems provide a series of patterns to a pixel panel, such as a deformable mirror device or a liquid crystal display. The pixel panel provides images consisting of a plurality of pixel elements, corresponding to the provided pattern, that may be projected onto the subject.

Each of the plurality of pixel elements is then simultaneously focused to different sites of the subject. The subject and pixel elements are then moved and the next image is provided responsive to the movement and responsive to the pixel-mask pattern. As a result, light can be projected onto or through the pixel panel to expose the plurality of pixel elements on the subject, and the pixel elements can be moved and altered, according to the pixel-mask pattern, to create contiguous images on the subject.

With reference now to FIG. 1a, a conventional analog photolithography system that uses a photomask can easily and accurately produce an image 10 on a subject 12. The image 10 can have horizontal, vertical, diagonal, and curved components (e.g., metal conductor lines) that are very smooth and of a consistent line width.

Referring also to FIG. 1b, a conventional digital photolithography system that uses a digital mask can also produce an image 14 on a subject 16. Although the image 14 can have horizontal, vertical, diagonal, and curved components, like the analog image 12 of FIG. 1a, some of the components (e.g., the diagonal ones) are neither very smooth nor of a consistent line width.

Certain improvements are desired for digital photolithograph systems, such as the ones described above. For one, it is desirable to provide smooth components, such as diagonal and curved metal lines, like those produced with analog photolithography systems. In addition, it is desired to have a relatively large exposure area, to provide good image resolution, to provide good redundancy, to use a relatively inexpensive incoherent light source, to provide high light energy efficiency, to provide high productivity and resolution, and to be more flexible and reliable.

### SUMMARY

A technical advance is provided by a novel method and system for performing digital lithography onto a subject. In one embodiment, the system includes a laser diode array for generating a digital pattern, where the array includes a plurality of laser diodes operable to project at least one laser beam. The system also includes a lens system for directing the digital pattern to the subject.

In another embodiment, the laser diode array is combined with the lens system to form a single unit. In yet another embodiment, the system includes a pixel panel and the laser diode array serves as a light source for the pixel panel. In still another embodiment, the system includes a lens array for reshaping the beam.

### BRIEF DESCRIPTION OF THE DRAWINGS

FIGS. 1a and 1b are images produced by a conventional analog photolithography system and a conventional digital photolithography system, respectively.

FIG. 2 is a block diagram of an improved digital photolithography system for implementing various embodiments of the present invention.

FIGS. 3a and 3b illustrate various overlay arrangement of pixels being exposed on a subject.

FIGS. 4a and 4b illustrate the effect of overlaid pixels on the subject.

FIG. 5 illustrates a component exposure from the system of FIG. 2, compared to conventional exposures from the systems of FIGS. 1b and 1a.

FIGS. 6a and 6b illustrate component exposures, corresponding to the images of FIGS. 1a and 1b, respectively.

FIG. 7 illustrates various pixel patterns being provided to a pixel panel of the system of FIG. 2.

FIGS. 8, 9, and 10.1-10.20 provide diagrams of a subject that is positioned and scanned at an angle on a stage. The angle facilitates the overlapping exposure of a site on the subject according to one embodiment of the present invention.

FIG. 11 is a block diagram of a portion of the digital photolithography system of FIG. 2 for implementing additional embodiments of the present invention FIGS. 12-13 provide diagrams of a subject that is positioned and scanned at an angle on a stage and being exposed by the system of FIG. 11.

FIG. 14 illustrates a site that has been overlapping exposed 600 times.

FIGS. 15-25 are block diagrams of several different digital photolithography systems for implementing various embodiments of the present invention.

FIG. 26 is a block diagram illustrating a digital photolithography system utilizing a laser diode array for implementing various embodiments of the present invention.

FIG. 27 illustrates an exemplary laser diode array that may be used in the system of FIG. 26.

FIG. 28 illustrates a macrostructure embodiment of the laser diode array of FIG. 27.

FIG. 29 illustrates a microstructure embodiment of the laser diode array of FIG. 27.

FIGS. 30-32 are block diagrams of several different digital photolithography systems for implementing various embodiments of the present invention.

FIG. 33 is a block diagram illustrating an implementation of the present invention as a high power light source.

### DETAILED DESCRIPTION

The present disclosure relates to exposure systems, such as can be used in semiconductor photolithographic processing. It is understood, however, that the following disclosure provides many different embodiments, or examples, for implementing different features of the invention. Specific examples of components and arrangements are described below to simplify the present disclosure. These are, of course, merely examples and are not intended to limit the invention from that described in the claims.

Maskless Photolithography System

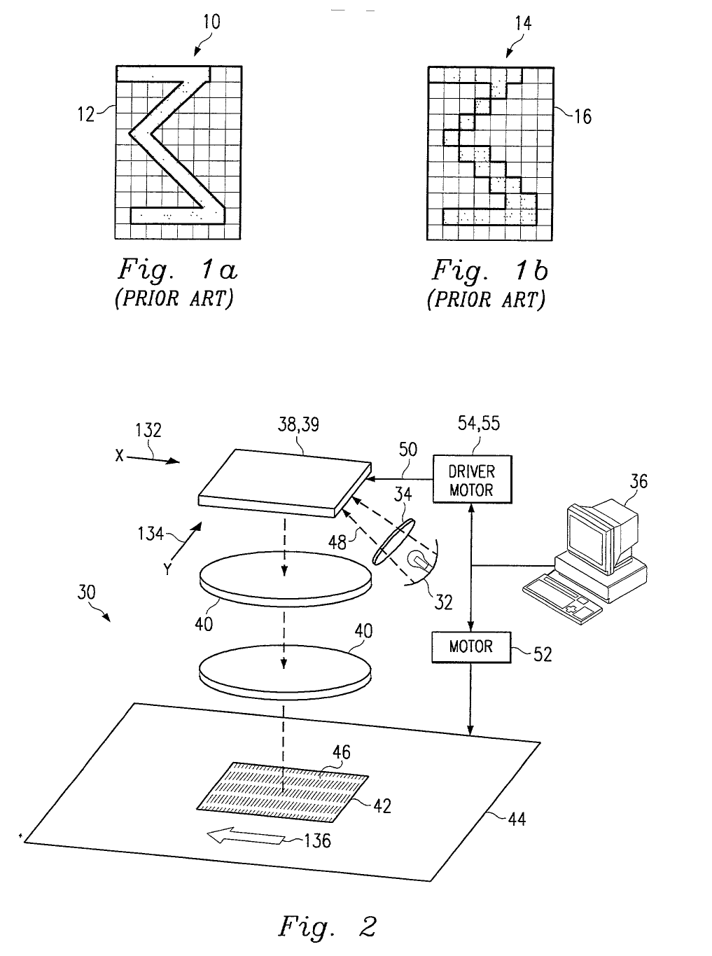

Referring now to FIG. 2, a maskless photolithography system 30 includes a light source 32, a first lens system 34, a computer aided pattern design system 36, a pixel panel 38, a panel alignment stage 39, a second lens system 40, a subject 42, and a subject stage 44. A resist layer or coating 46 may be disposed on the subject 42. The light source 32 may be an incoherent light source (e.g., a Mercury lamp) that provides a collimated beam of light 48 which is projected through the first lens system 34 and onto the pixel panel 38.

The pixel panel 38 is provided with digital data via suitable signal line(s) 50 from the computer aided pattern design system 36 to create a desired pixel pattern (the pixel-mask pattern). The pixel-mask pattern may be available and resident at the pixel panel 38 for a desired, specific duration. Light emanating from (or through) the pixel-mask pattern of the pixel panel 38 then passes through the second lens system 40 and onto the subject 42. In this manner, the pixel-mask pattern is projected onto the resist coating 46 of the subject 42.

The computer aided mask design system 36 can be used for the creation of the digital data for the pixel-mask pattern. The computer aided pattern design system 36 may include computer aided design (CAD) software similar to that which is currently used for the creation of mask data for use in the manufacture of a conventional printed mask. Any modifications and/or changes required in the pixel-mask pattern can be made using the computer aided pattern design system 36. Therefore, any given pixel-mask pattern can be changed, as needed, almost instantly with the use of an appropriate instruction from the computer aided pattern design system 36. The computer aided mask design system 36 can also be used for adjusting a scale of the image or for correcting image distortion.

In the present embodiment, the pixel panel 38 is a digital light processor (DLP) or digital mirror device (DMD) such as is illustrated in U.S. Pat. No. 5,079,544 and patents referenced therein. Current DMD technology provides a 600×800 array of mirrors for a set of potential pixel elements. Each mirror can selectively direct the light 48 towards the subject 42 (the “ON” state) or away from the subject (the “OFF” state). Furthermore, each mirror can alternate between ON and OFF for specific periods of time to accommodate variations in light efficiency. For example, if the second lens system 40 has a “darker” area (e.g., a portion of the lens system is inefficient or deformed), the DMD can alternate the mirrors corresponding with the “brighter” areas of the lens, thereby equalizing the overall light energy projected through the lens. For the sake of simplicity and clarity, the pixel panel 38 will be further illustrated as one DMD. Alternate embodiments may use multiple DMDs, one or more liquid crystal displays and/or other types of digital panels.

In some embodiments, the computer aided mask design system 36 is connected to a first motor 52 for moving the stage 44, and a driver 54 for providing digital data to the pixel panel 38. In some embodiments, an additional motor 55 may be included for moving the pixel panel, as discussed below. The system 36 can thereby control the data provided to the pixel panel 38 in conjunction with the relative movement between the pixel panel 38 and the subject 42.

Pixel Overlay

The amount of exposure time, or exposure intensity, of light from the pixel panel 38 directly affects the resist coating 46. For example, if a single pixel from the pixel panel 38 is exposed for a maximum amount of time onto a single site of the subject 42, or for a maximum intensity, then the corresponding portion of resist coating 46 on the subject would have a maximum thickness (after non-exposed or under exposed resist has been removed). If the single pixel from the pixel panel 38 is exposed for less than the maximum amount of time, or at a reduced intensity, the corresponding portion of resist coating 46 on the subject 42 would have a moderate thickness. If the single pixel from the pixel panel 38 is not exposed, then the corresponding portion of resist coating 42 on the subject 42 would eventually be removed.

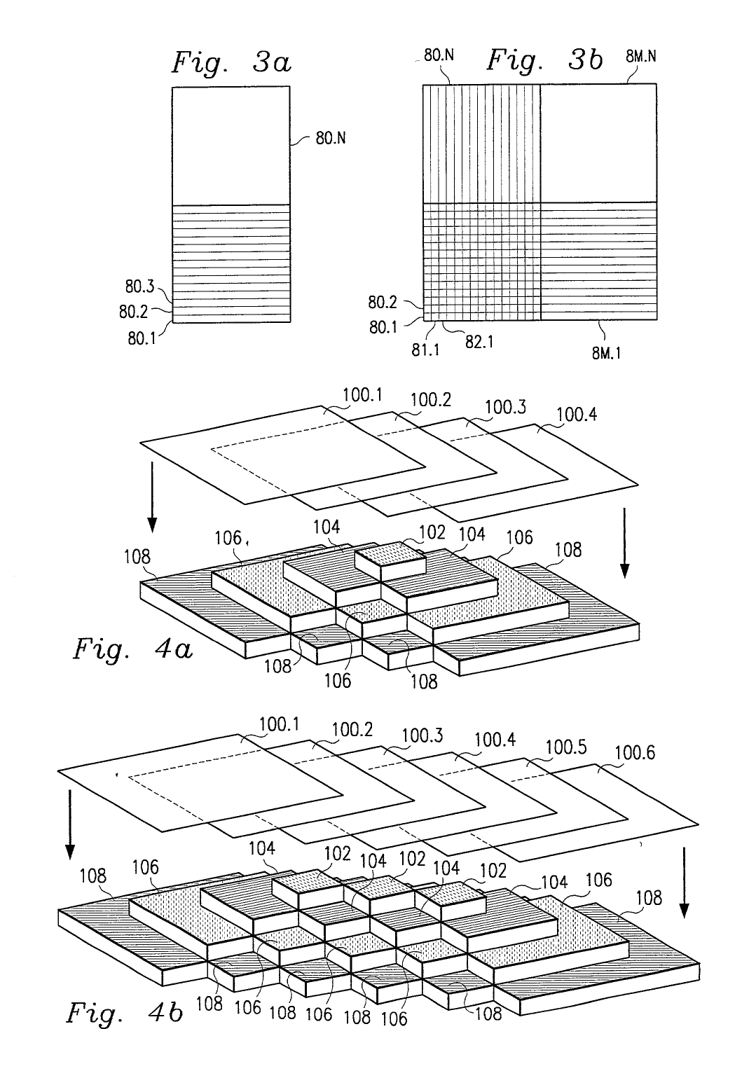

Referring now to FIGS. 3a and 3b, it is desired that each pixel element exposed onto a site overlap previous pixel element exposures. FIG. 3a shows a one-direction overlay scenario where a pixel element 80.1 is overlapped by pixel element 80.2, which is overlapped by pixel element 80.3, . . . which is overlapped by pixel element 80.N, where “N” is the total number of overlapped pixel elements in a single direction. It is noted that, in the present example, pixel element 80.1 does not overlay pixel element 80.N.

FIG. 3b is a two-dimensional expansion FIG. 3a. In this example, pixel element 80.1 is overlapped in another direction by pixel element 81.1, which is overlapped by pixel element 82.1, . . . which is overlapped by pixel element 8M.N, where “M” is the total number of overlapped pixel elements in a second direction. As a result, a total of M×N pixel elements can be exposed for a single site.

Referring now to FIG. 4a, consider for example a site that has the potential to be exposed by (M,N)=(4,4) pixel elements. In this example, only four of the 16 possible pixel elements are actually “ON”, and therefore expose portions of the subject 42. These four pixel elements are designated: 100.1, 100.2, 100.3, 100.4. The four pixel elements 100.1-100.4 are exposed onto the photo resist 46 of the subject 42. All four pixel elements 100.1-100.4 overlap with each other at an area 102; three of the pixel elements overlap at an area 104; two of the pixel elements overlap at an area 106; and an area 108 is only exposed by one pixel element. Accordingly, area 102 will receive maximum exposure (100%); area 104 will receive 75% exposure; area 106 will receive 50% exposure; and area 108 will receive 25% exposure. It is noted that the area 102 is very small, 1/16th the size of any pixel element 100.1-100.4 in the present example.

Referring now to FIG. 4b, the example of FIG. 4a can be expanded to (M,N)=(6,6) pixel elements, with two more overlapping pixel elements 100.5, 100.6 in the ON state. The pixel elements 100.5, 100.6 are therefore exposed onto the photo resist 46 of the subject 42 so that they overlap some of the four pixel elements 100.1-100.4. In this expanded example, the pixel elements 100.1-100.4 overlap with each other at area 102; the four pixel elements 100.2-100.5 overlap each other at an area 110; and the four pixel elements 100.3-100.6 overlap each other at an area 112. In addition, area 114 will receive 75% exposure; area 116 will receive 50% exposure; and area 118 will receive 25% exposure. As a result, a very small ridge is formed on the photo resist 46.

In one embodiment, the pixel panel 32 of the present invention may have a 600×800 array of pixel elements. The overlapping is defined by the two variables: (M,N). Considering one row of 600 pixels, the system overlaps the 600 pixels onto an overlay area 184 of:

(M,N)=20 pixels×30 pixels. (1)

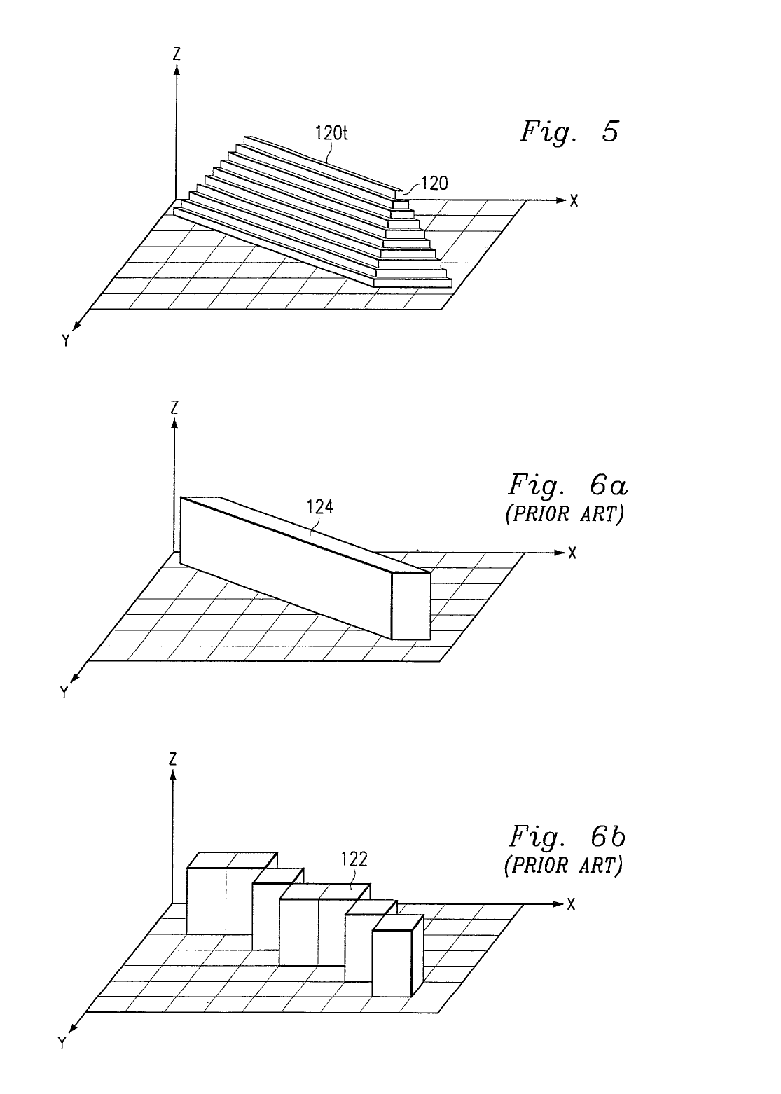

Referring also to FIG. 5a, the process of FIGS. 4a and 4b can be repeated to produce a diagonal component 150 on the subject 42. Although the example of FIGS. 4a and 4b have only four potential degrees of exposure (100%, 75%, 50%, 25%), by increasing the number of overlaps (such as is illustrate in FIG. 3b), it is possible to have a very fine resolution of desired exposure.

The diagonal component 120 appears as a prism-shaped structure having a triangular cross-section. If the subject 42 is a wafer, the component 120 may be a conductor (e.g., a metal line), a section of poly, or any other structure. The top most portion 120t of the component is the portion of photo resist 46 that is overlapped the most by corresponding pixel elements, and therefore received the maximum exposure.

The component 120 is contrasted with a component 122 of FIG. 5b and a component 124 of FIG. 5c. The component 122 of FIG. 5b illustrates a conventional digital component. The component 124 of FIG. 5c illustrates a conventional analog component.

Overlay Methods

Referring again to FIG. 2, the above-described overlays can be implemented by various methods. In general, various combinations of moving and/or arranging the pixel panel 38 and/or the subject 42 can achieve the desired overlap.

In one embodiment, the maskless photolithography system 30 performs two-dimensional digital scanning by rapidly moving the image relative to the subject in two directions (in addition to the scanning motion). The panel motor 55 is attached to the pixel panel 38 to move the pixel panel in two directions, represented by an x-arrow 132 and a y-arrow 134. The panel motor 55 may be a piezo electric device (PZT) capable of making very small and precise movements.

In addition, the scanning motor 55 scans the stage 44, and hence the subject 42, in a direction 136. Alternatively, the stage 44 can be fixed and the panel motor 55 can scan the pixel panel 38 (and the lenses 40) opposite to direction 136.

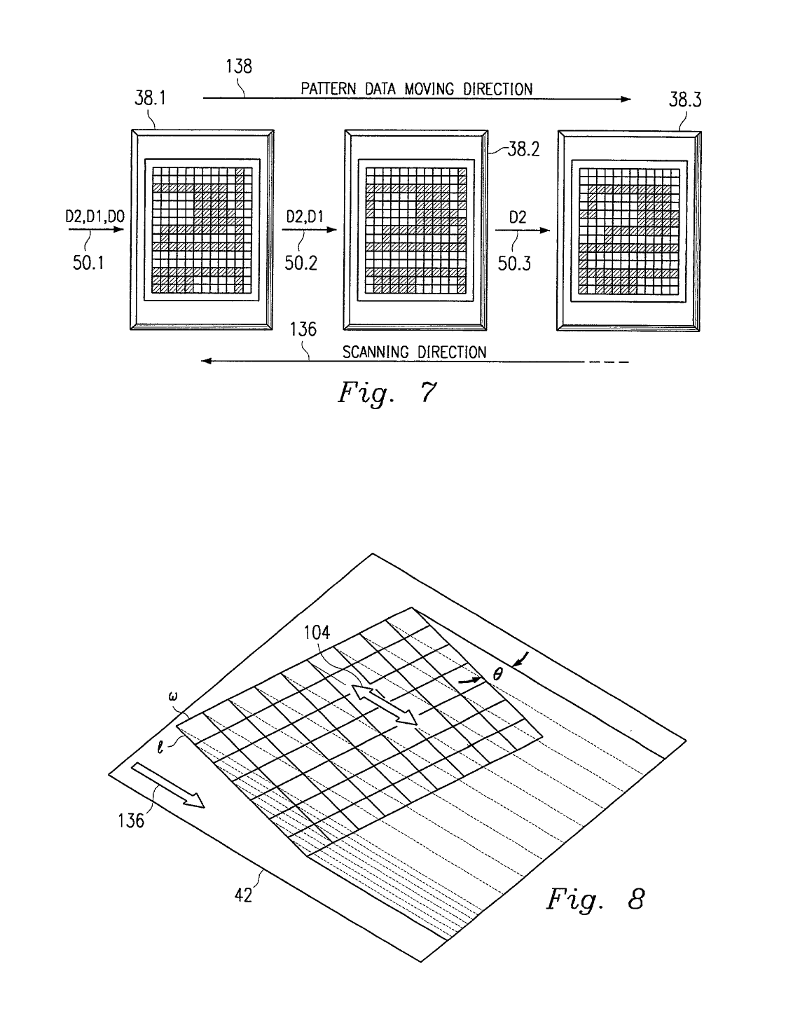

Referring also to FIG. 7, corresponding to the image scanning described above, the pixel-mask pattern being projected by the pixel panel 38 changes accordingly. This correspondence can be provided, in one embodiment, by having the computer system 36 (FIG. 2) control both the scanning movement 70 and the data provided to the pixel panel 38. The illustrations of FIG. 7 and the following discussions describe how the data can be timely provided to the pixel panel.

FIG. 7 shows three intermediate patterns of pixel panel 38. Since the pattern on the pixel panel 38 and the data on the signal lines 50 change over time, the corresponding patterns on the pixel panel and data on the signal lines at a specific point in time are designated with a suffix “.1”, “.2”, or “.3”. In the first intermediate pattern, the pattern of pixel panel 38.1 is created responsive to receiving data DO provided through the signal lines 50.1. In the present example, the pattern is created as a matrix of pixel elements in the pixel panel 38.1. After a predetermined period of time (e.g., due to exposure considerations being met), the pattern is shifted. The shifted pattern (now shown as pixel panel 38.2) includes additional data D1 provided through the signal lines 38.2. The shifting between patterns may also utilize a strobing or shuttering of the light source 32.

In the second intermediate pattern of FIG. 7, D1 represents the left-most column of pixel elements in the pattern of DMD38.2. After another predetermined period of time, the pattern (now shown as pixel panel 38.3) is shifted again. The twice-shifted pattern includes additional data D2 provided through the signal lines 38.2. In the third intermediate pattern of FIG. 7, D2 now represents the left-most column of pixel elements in the pattern of the DMD38.3. Thus, the pattern moves across the pixel panel 38 in a direction 138. It is noted that the pattern direction 138, as it is being provided to the pixel panel 38 from the signal lines 50, is moving opposite to the scanning direction 136. In some embodiments, the pattern may be shifted in additional directions, such as perpendicular to the scanning direction 136.

Referring now to FIG. 8, in some embodiments, the maskless photolithography system 30 performs two-dimensional digital scanning by rapidly moving the image relative to the subject 42 in one direction (in addition to the scanning motion) while the subject is positioned on the stage 44 to accommodate the other direction. The panel motor 55 moves the pixel panel 38 in one direction, represented by the y-arrow 134. The scanning motor 55 scans the stage 44, and hence the subject 42 in a direction 136. Alternatively, the stage 44 can be fixed and the panel motor 55 can scan the pixel panel 38 (and the lenses 40) opposite to direction 136.

The image from the pixel panel 38 and/or the subject 42 is aligned at an angle θ with the scan direction 136. Considering that each pixel projected onto subject 42 has a length of l and a width of w, then θ can be determined as:

$$θ = {tan}^{- 1} ( \frac{w - 1 / M}{N \times l} ) \qquad ( 2 )$$

In another embodiment, the offset may go in the opposite direction, so that θ can be determined as:

$$θ = {tan}^{- 1} ( \frac{w + 1 / M}{N \times l} ) \qquad ( 3 )$$

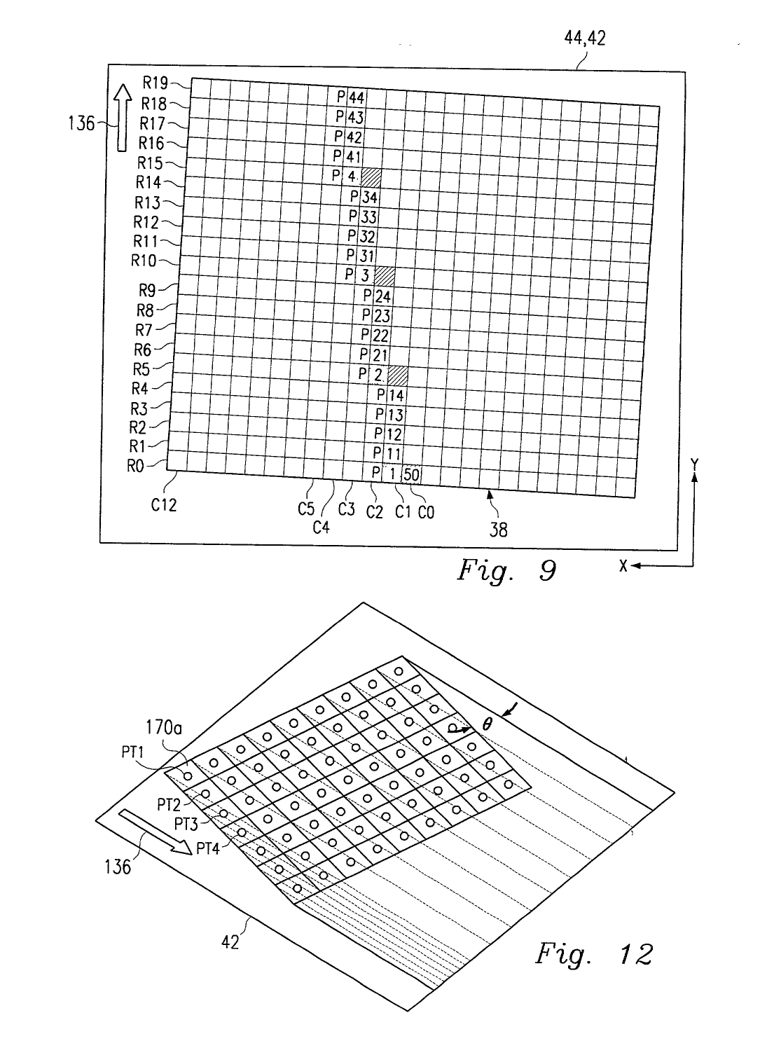

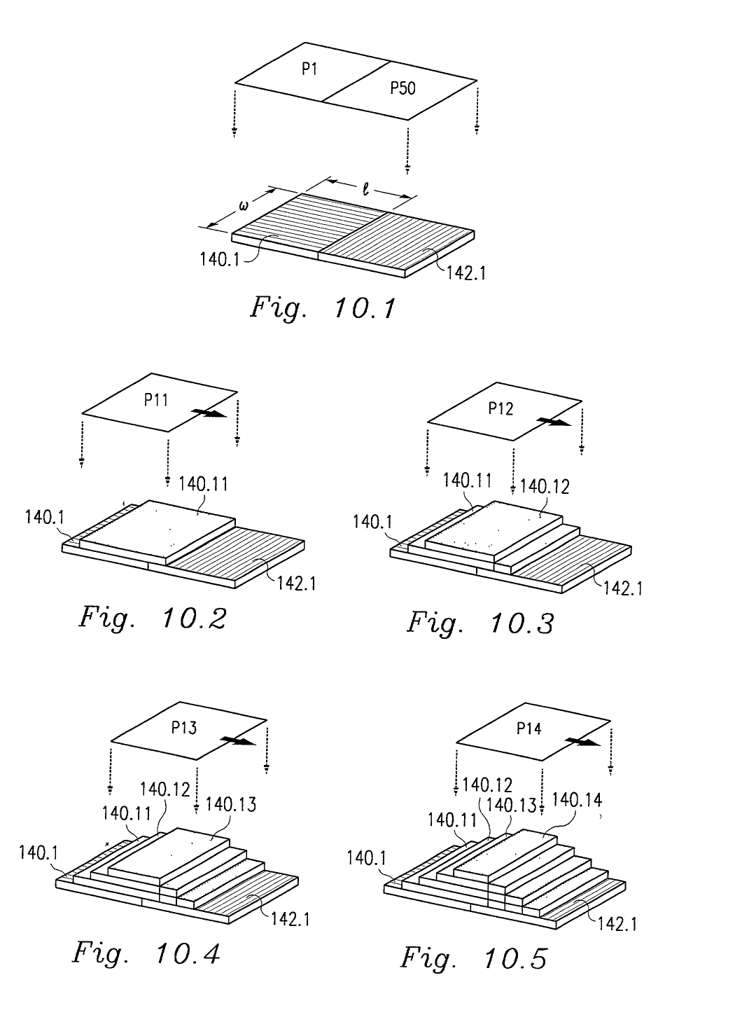

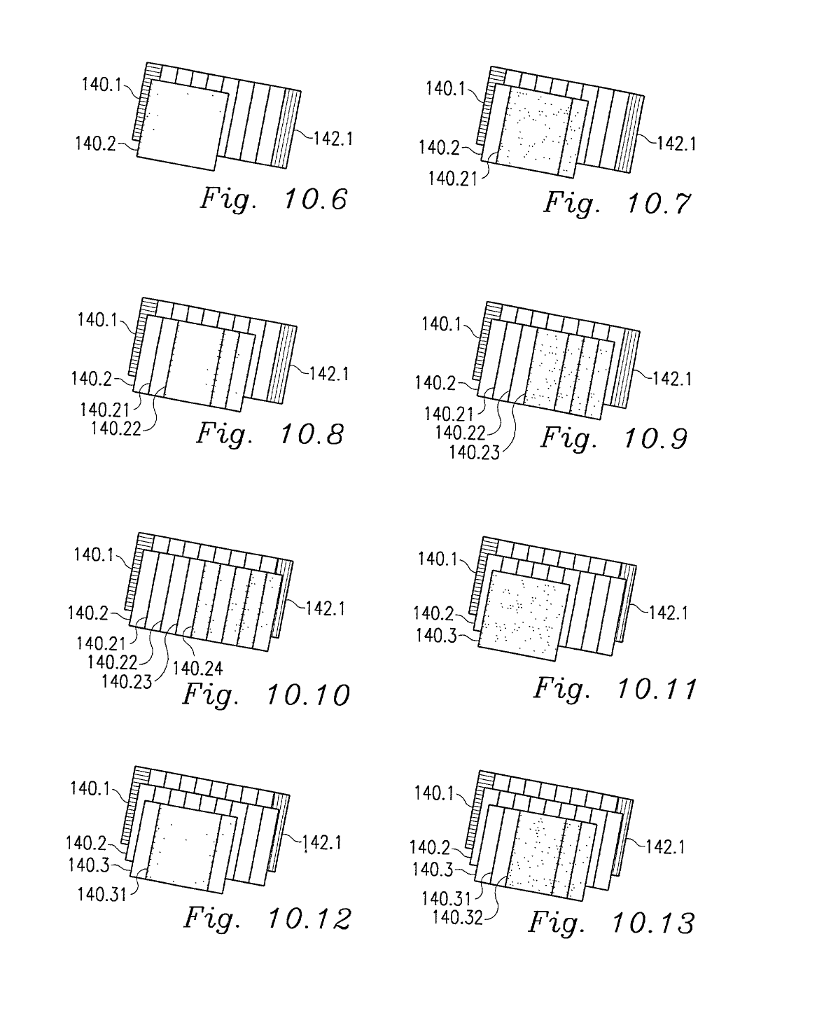

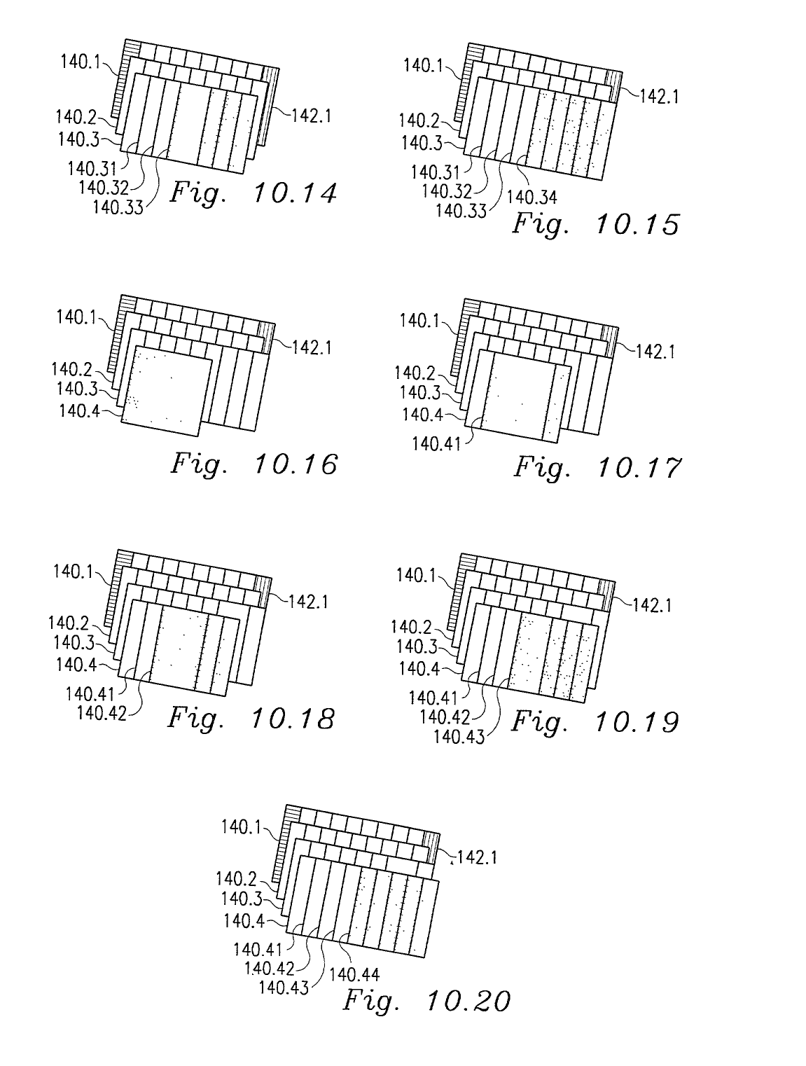

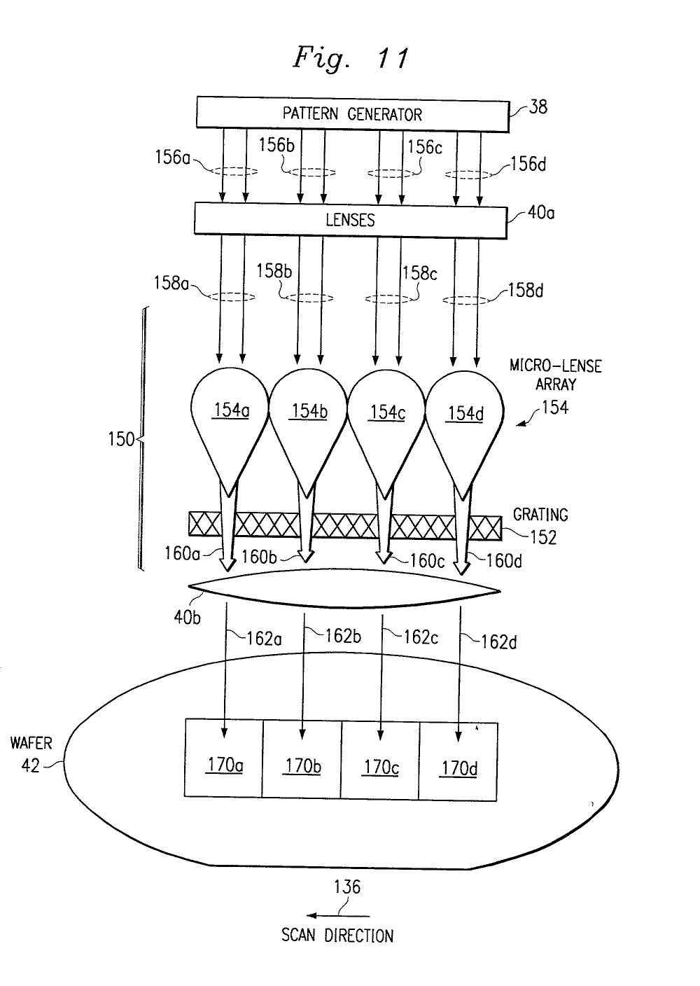

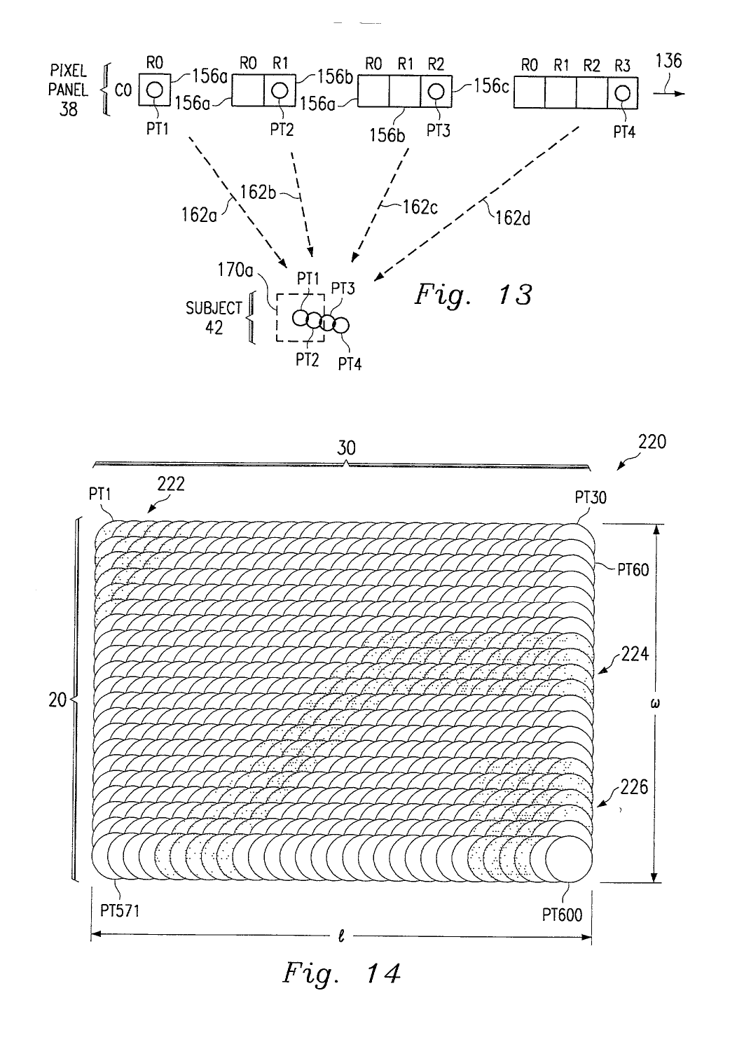

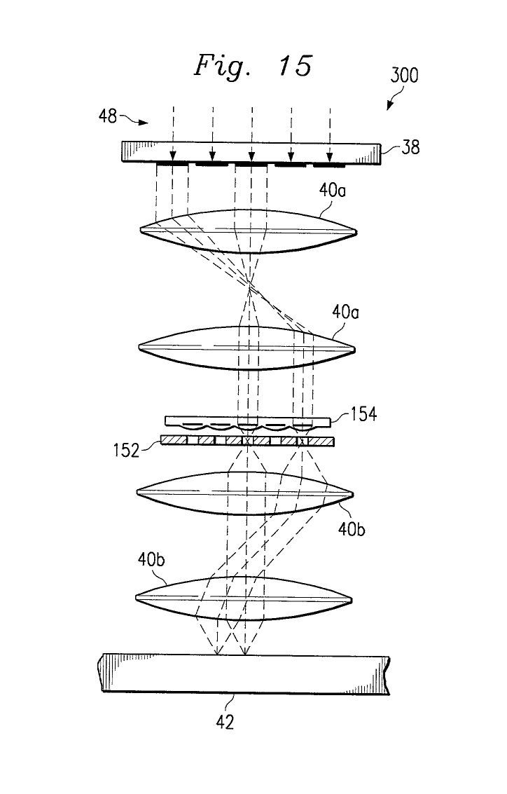

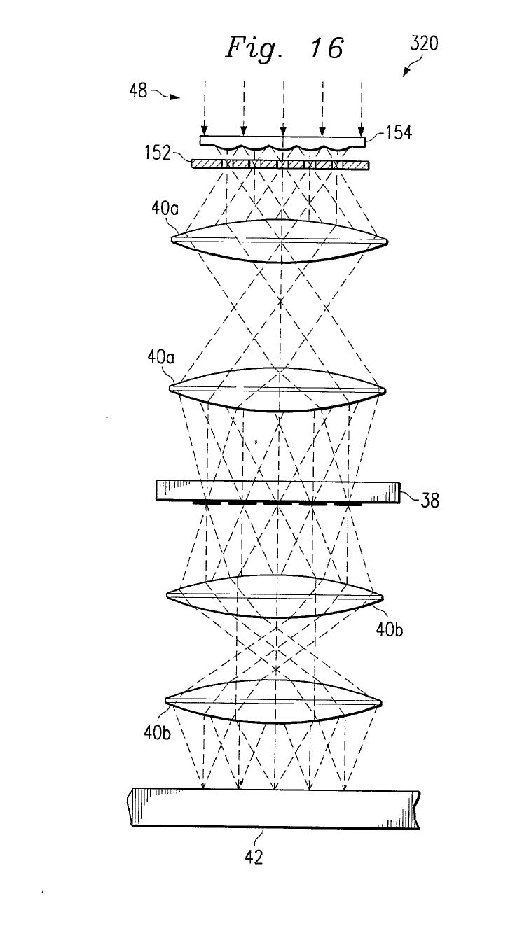

Referring to FIGS. 9 and 10.1, consider for example two sites 140.1, 142.1 on the subject 42. Initially, the two sites 140.1 and 142.1 are simultaneously exposed by pixel elements P1 and P50, respectively, of the pixel panel 38. The pixel elements P1 and P50 are located at a row RO and columns C1 and C0, respectively, of the pixel panel 38. This row and column designation is arbitrary, and has been identified in the present embodiment to clarify the example. The following discussion will focus primarily on site 140.1. It is understood, however, that the methods discussed herein are typically applied to multiple sites of the subject, including the site 142.1, but further illustrations and discussions with respect to site 142.1 will be avoided for the sake of clarity.

As can be clearly seen in FIG. 9, the pixel panel 38 is angled with respect to the subject 42 and the scan direction 136. As the system 30 scans, pixel element P11 would normally be projected directly on top of site 140.1. However, as shown in FIG. 10.2, the pixel element P11 exposes at a location 140.11 that is slightly offset in the y direction (or -y direction) from the site 140.1. As the system 30 continues to scan, pixel elements P12-P14 are exposed on offset locations 140.12-140.14, respectively, shown in FIGS. 10.3-10.5, respectively. Pixel elements P11-P14 are on adjacent consecutive rows R1, R2, R3, R4 of column C1 of the pixel panel 38.

In the present embodiment, the scanning motor 52 moves the stage 44 (and hence the subject 42) a distance of l, the length of the pixel site 140.1, for each projection. To provide the offset discussed above, the panel motor 55 moves the pixel panel 38 an additional distance of l/(N−1) for each projection. (N=5 in the present example). Therefore, a total relative movement SCAN STEP for each projection is:

SCAN STEP=l+l/(N−1). (4)

In another embodiment, the offset may go in the opposite direction, so that the total relative movement SCAN STEP for each projection is:

SCAN STEP=l−l/(N−1). (5)

In some embodiments, the panel motor 55 is not needed. Instead, the scanning motor 52 moves the stage the appropriate length (equation 4 or 5, above).

Once N locations have been exposed, the next pixel elements being projected onto the desired locations are of an adjacent column. With reference to FIG. 10.6, in the present example, a pixel element P2 at row R5, column C2 exposes a location 140.2 that is slightly offset in the x direction (or -x direction, depending on whether equation 4 or 5 is used) from the site 140.1. As the system 30 continues to scan, pixel elements P21-P24 are exposed on offset locations 140.21-140.24, respectively, shown in FIGS. 10.7-10.10, respectively. Pixel elements P21-P24 are on adjacent consecutive rows R6, R7, R8, R9 of column C2 of the pixel panel 38.

Once N more pixel locations have been exposed, the next pixel elements being projected onto the desired locations are of yet another adjacent column. With reference to FIG. 10.11, in the present example, a pixel element P3 at row RIO, column C3 exposes a location 140.3 that is slightly offset in the x direction (or -x direction, depending on whether equation 4 or 5 is used) from the location 140.2. As the system 30 continues to scan, pixel elements P31-P34 are exposed on offset locations 140.31-140.34, respectively, shown in FIGS. 10.12-10.15, respectively. Pixel elements P31-P34 are on adjacent consecutive rows R11, R12, R13, R14 of column C3 of the pixel panel 38.

The above process repeats to fully scan the desired overlapped image. With reference to FIG. 10.16, in the present example, a pixel element P4 at row R15, column C4 exposes a location 140.4 that is slightly offset in the x direction (or -x direction, depending on whether equation 4 or 5 is used) from the location 140.3. As the system 30 continues to scan, pixel elements P41-P44 are exposed on offset locations 140.41-140.44, respectively, shown in FIGS. 10.17-10.20, respectively. Pixel elements P41-P44 are on adjacent consecutive rows R16, R17, R18, R19 of column C4 of the pixel panel 38.

Point Array System and Method

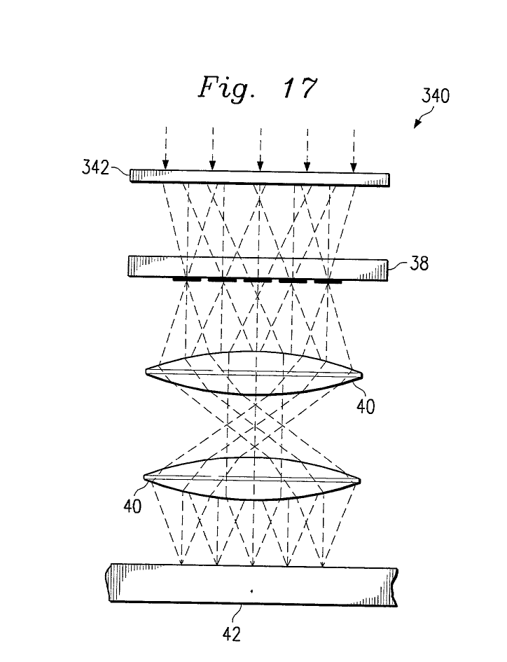

Referring now to FIG. 11, in another embodiment of the present invention, the photolithography system 30 utilizes a unique optic system 150 in addition to the lens system 40. The optic system 150 is discussed in detail in U.S. patent Ser. No. 09/480,796, which is hereby incorporated by reference. It is understood that the lens system 40 is adaptable to various components and requirements of the photolithography system 30, and one of ordinary skill in the art can select and position lenses appropriately. For the sake of example, a group of lenses 40a and an additional lens 40b are configured with the optic system 150.

The optic system 150 includes a grating 152 and a point array 154. The grating 152 may be a conventional shadow mask device that is used to eliminate and/or reduce certain bandwidths of light and/or diffractions between individual pixels of the pixel panel 38. The grating 152 may take on various forms, and in some embodiments, may be replaced with another device or not used at all.

The point array 154 is a multi-focus device. There are many types of point arrays, including a Fresnel ring, a magnetic e-beam lens, an x-ray controlled lens, and an ultrasonic controlled light condensation device for a solid transparent material.

In the present embodiment, the point array 154 is a compilation of individual microlenses, or microlens array. In the present embodiments, there are as many individual microlenses as there are pixel elements in the pixel panel 38. For example, if the pixel panel 38 is a DMD with 600×800 pixels, then the microlens array 154 may have 600×800 microlenses. In other embodiments, the number of lenses may be different from the number of pixel elements in the pixel panel 38. In these embodiments, a single microlens may accommodate multiple pixels elements of the DMD, or the pixel elements can be modified to account for alignment. For the sake of simplicity, only one row of four individual lenses 154a, 154b, 154c, 154d will be illustrated. In the present embodiment, each of the individual lenses 154a, 154b, 154c, 154d is in the shape of a rain drop. It is understood, however, that shapes other than those illustrated may also be used.

Similar to the lens system 40 of FIG. 2, the optic system 150 is placed between the pixel panel 38 and the subject 42. For the sake of example, in the present embodiment, if the pixel panel 38 is a DMD device, light will (selectively) reflect from the DMD device and towards the optic system 150. If the pixel panel 38 is a liquid crystal display (“LCD”) device or a transparent spatial light modulator (“SLM”), light will (selectively) flow through the LCD device and towards the optic system 150. To further exemplify the present embodiment, the pixel panel 38 includes one row of elements (either mirrors or liquid crystals) for generating four pixel elements.

In continuance with the example, four different pixel elements 156a, 156b, 156c, 156d are projected from each of the pixels of the pixel panel 38. In actuality, the pixel elements 156a, 156b, 156c, 156d are light beams that may be either ON or OFF at any particular instant (meaning the light beams exist or not, according to the pixel-mask pattern), but for the sake of discussion all the light beams are illustrated.

The pixel elements 156a, 156b, 156c, 156d pass through the lens system 40a and are manipulated as required by the current operating conditions. As discussed earlier, the use of the lens system 40a and 40b are design options that are well understood in the art, and one or both may not exist in some embodiments. The pixel elements 156a, 156b, 156c, 156d that are manipulated by the lens system 40a are designated 158a, 158b, 158c, 158d, respectively.

The pixel elements 158a, 158b, 158c, 158d then pass through the microlens array 154, with each beam being directed to a specific microlens 154a, 154b, 154c, 154d, respectively. The pixel elements 158a, 158b, 158c, 158d that are manipulated by the microlens array 154 are designated as individually focused light beams 160a, 160b, 160c, 160d, respectively. As illustrated in FIG. 11, each of the light beams 160a, 160b, 160c, 160d are being focused to focal points 162a, 162b, 162c, 162d for each pixel element. That is, each pixel element from the pixel panel 38 is manipulated until it focuses to a specific focal point. It is desired that the focal points 162a, 162b, 162c, 162d exist on the subject 42. To achieve this goal, the lens 40b may be used in some embodiments to refocus the beams 160a, 160b, 160c, 160d on the subject 42. FIG. 11 illustrates focal points 162a, 162b, 162c, 162d as singular rays, it being understood that the rays may not indeed be focused (with the possibility of intermediate focal points, not shown) until they reach the subject 42.

Continuing with the present example, the subject 42 includes four exposure sites 170a, 170b, 170c, 170d. The sites 170a, 170b, 170c, 170d are directly associated with the light beams 162a, 162b, 162c, 162d, respectively, from the microlenses 154a, 154b, 154c, 154d, respectively. Also, each of the sites 170a, 170b, 170c, 170d are exposed simultaneously. However, the entirety of each site 170a, 170b, 170c, 170d is not exposed at the same time.

Referring now to FIG. 12, the maskless photolithography system 30 with the optic system 150 can also performs two-dimensional digital scanning, as discussed above with reference to FIG. 8. For example, the image from the pixel panel 38 may be aligned at the angle θ (equations 2 and 3, above) with the scan direction 136.

Referring also to FIGS. 13, the present embodiment works very similar to the embodiments of FIGS. 9-10. However, instead of a relatively large location being exposed, the pixel elements are focused and exposed to a relatively small point (e.g., individually focused light beams 162a, 162b, 162c, 162d from FIG. 11) on the sites 170a, 170b, 170c, 170d.

First of all, the pixel element 156a exposes the individually focused light beam 162a onto the single site 170a of the subject 42. The focused light beam 162a produces an exposed (or unexposed, depending on whether the pixel element 156a is ON or OFF) focal point PT1. As the system 30 scans, pixel element 156b exposes the individually focused light beam 162b onto the site 170a. The focused light beam 162b produces an exposed (or unexposed) focal point PT2. Focal point PT2 is slightly offset from the focal point PT1 in the y direction (or -y direction). As the system 30 continues to scan, pixel elements 156c and 156d expose the individually focused light beams 162c and 162d, respectively, onto the site 170a. The focused light beams 162c and 162d produce exposed (or unexposed) focal points PT3 and PT4, respectively. Focal point PT3 is slightly offset from the focal point PT2 in the y direction (or -y direction), and focal point PT4 is similarly offset from the focal point PT3.

Once N pixel elements have been projected, the next pixels being projected onto the desired sites are of an adjacent column. This operation is similar to that shown in FIGS. 10.6-10.20. The above process repeats to fully scan the desired overlapped image on the site 170a.

It is understood that while light beam 162a is being exposed on the site 170a, light beam 162b is being exposed on the site 170b, light beam 162c is being exposed on the site 170c, and light beam 162d is being exposed on the site 170d. Once the system 30 scans one time, light beam 162a is exposed onto a new site (not shown), while light beam 162b is exposed on the site 170a, light beam 162c is exposed on the site 170b, and light beam 162d is exposed on the site 170c. This repeats so that the entire subject can be scanned (in the y direction) by the pixel panel 38.

It is further understood that in some embodiments, the substrate 42 may be moved rapidly while the light beams (e.g., 162a-d) transition from one site to the other (e.g., 170a-170d, respectively), and slowly while the light beams are exposing their corresponding sites.

By grouping several pixel panels together in the x-direction, the entire subject can be scanned by the pixel panels. The computer system 36 can keep track of all the data provided to each pixel panel to accommodate the entire scanning procedure. In other embodiments, a combination of scanning and stepping can be performed. For example, if the subject 42 is a wafer, a single die (or group of die) can be scanned, and then the entire system 30 can step to the next die (or next group).

The example of FIGS. 11-13 are limited in the number of pixel elements for the sake of clarity. In the figures, each focal point has a diameter of about ½ the length l or width w of the site 170a. Since N=4 in this example, the overlap spacing is relatively large and the focal points do not overlap very much, if at all. As the number of pixel elements increase (and thus N increases), the resolution and amount of overlapping increase, accordingly.

For further example, FIG. 14 illustrates a site 220 that has been exposed by 600 pixel elements with focal points PT1-PT600 (e.g., from a 600×800 DMD). As can be seen, the focal points PT1-PT600 are arranged in an array (similar to equation 1, above) of:

(M,N)=20 focal points×30 focal points. (6)

By selectively turning ON and OFF the corresponding pixel elements, a plurality of structures 222, 224, 226 can be formed on the site 220. It is noted that structures 222-226 have good resolution and can be drawn to various different shapes, including diagonal. It is further noted that many of the focal points on the periphery of the site 220 will eventually overlap with focal points on adjacent sites. As such, the entire subject 42 can be covered by these sites.

Alternatively, certain focal points or other types of exposed sites can be overlapped to provide sufficient redundancy in the pixel panel 38. For example, the same 600 focal points of FIG. 14 can be used to produce an array of:

(M,N)=20 focal points×15 focal points. (7)

By duplicating the exposure of each focal point, this redundancy can accommodate one or more failing pixel elements in the pixel panel 38.

Additional Embodiments of the Point Array System

FIGS. 15-27, below, describe additional configurations of the point array system that can be implemented, each providing different advantages. To the extent that similar components are used as those listed in FIGS. 2 and 11, the same reference numerals will also be used.

Referring now to FIG. 15, a maskless photolithography system 300 is similar to the systems of FIGS. 2 and 11. The system 300 includes a transparent spatial light modulator (“SLM”) as the pixel panel 38. The light 48 passes through the SLM 38 and, according to the pixel pattern provided to the SLM, is selectively transmitted towards the substrate 42.

Referring now to FIG. 16, a maskless photolithography system 320 is similar to the system 300 of FIG. 15, except that it positions the micro-lens array 154 and the grating 152 before (as determined by the flow of light 48) the SLM 38.

Referring now to FIG. 17, a maskless photolithography system 340 is similar to the system 320 of FIG. 16, except that it uses an optical diffraction element 342 instead of the micro-lens array 154 and grating 152. The optical diffraction element 342 may be of the type used for holograms, or a binary diffraction component.

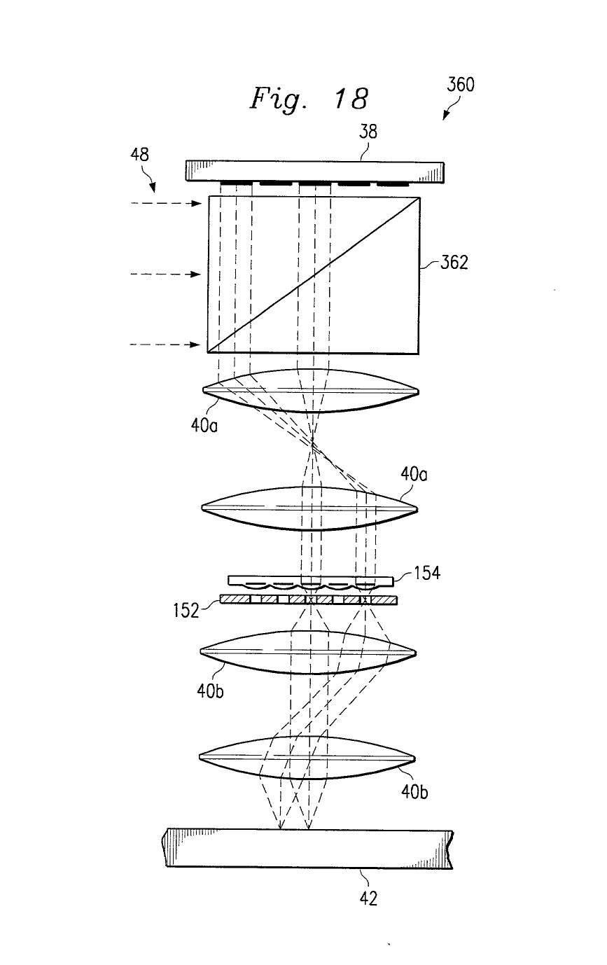

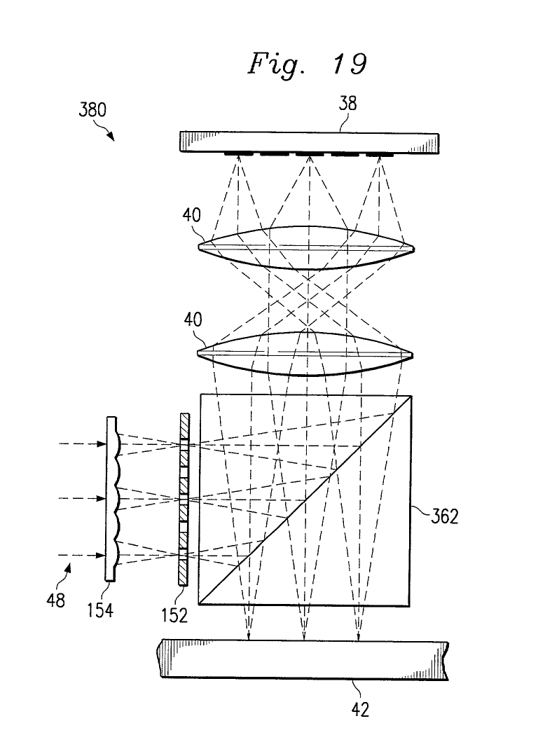

Referring now to FIG. 18, a maskless photolithography system 360 is similar to the system 320 of FIG. 16, except that the SLM 38 is non-transparent. For this system 360, a beam splitter 362 is used to direct the incoming light 48 towards the SLM 38, and the reflected image towards the lens system 40a.

Referring now to FIG. 19, a maskless photolithography system 380 is similar to the system 360 of FIG. 18, except for the location of the components. The incoming light 48 first passes through the microlens array 154, the grating 152, and then through the beam splitter 362. At this time, the light is separately focusable into individual pixels. The pixelized light then reflects off the SLM 38 and the resulting image passes back through the beam splitter 362 and onto the subject 42.

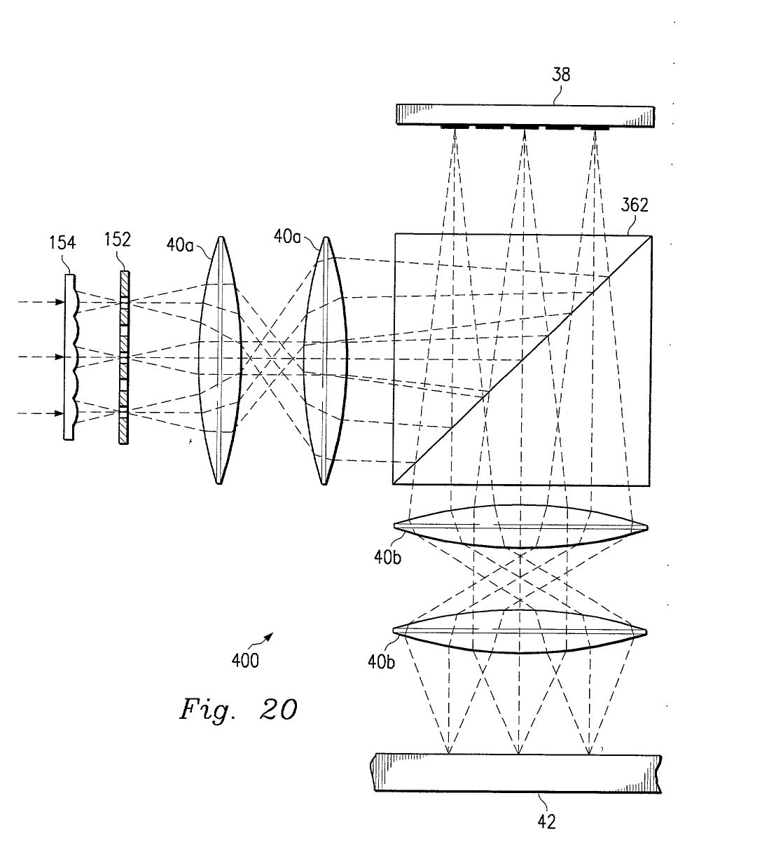

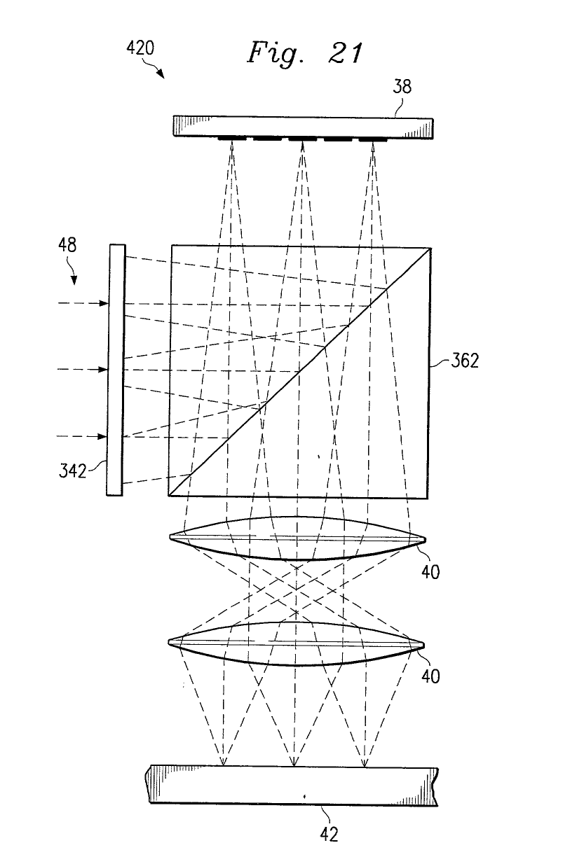

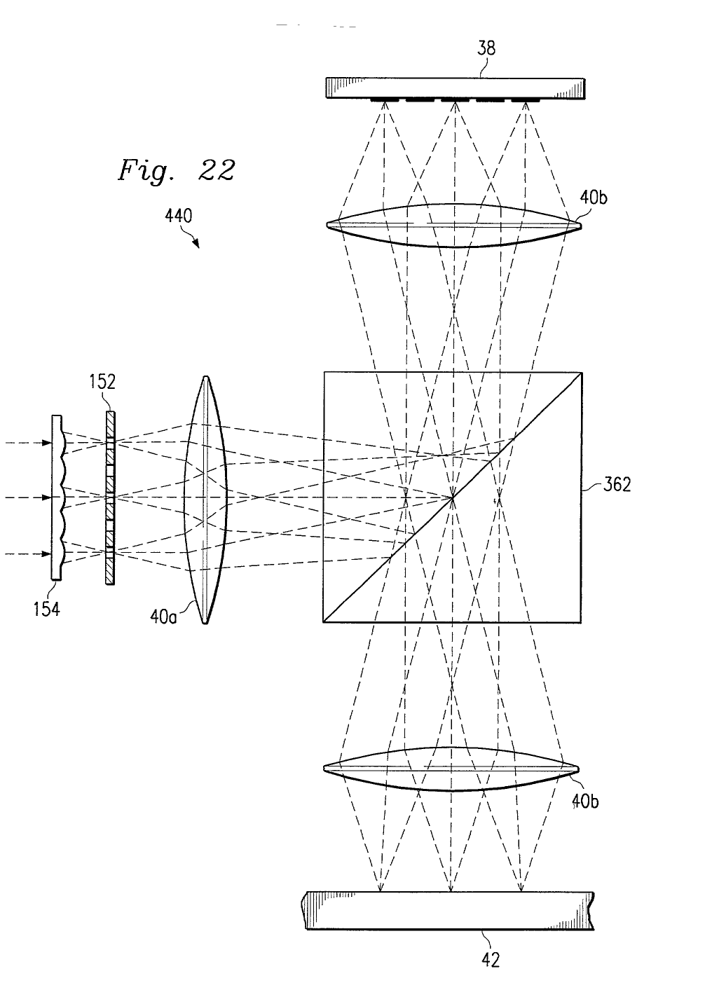

Referring now to FIG. 20, a maskless photolithography system 400 is similar to the system 380 of FIG. 19, except that the beam splitter 382 is positioned adjacent to the SLM 38.

Referring now to FIG. 21, a maskless photolithography system 420 is similar to the system 400 of FIG. 20, except that instead of a microlens array and grating, the system uses the optical diffraction component 342.

Referring now to FIG. 22, a maskless photolithography system 440 is similar to the system 400 of FIG. 20, except that the image lens 40b is positioned on both sides of the beam splitter 382.

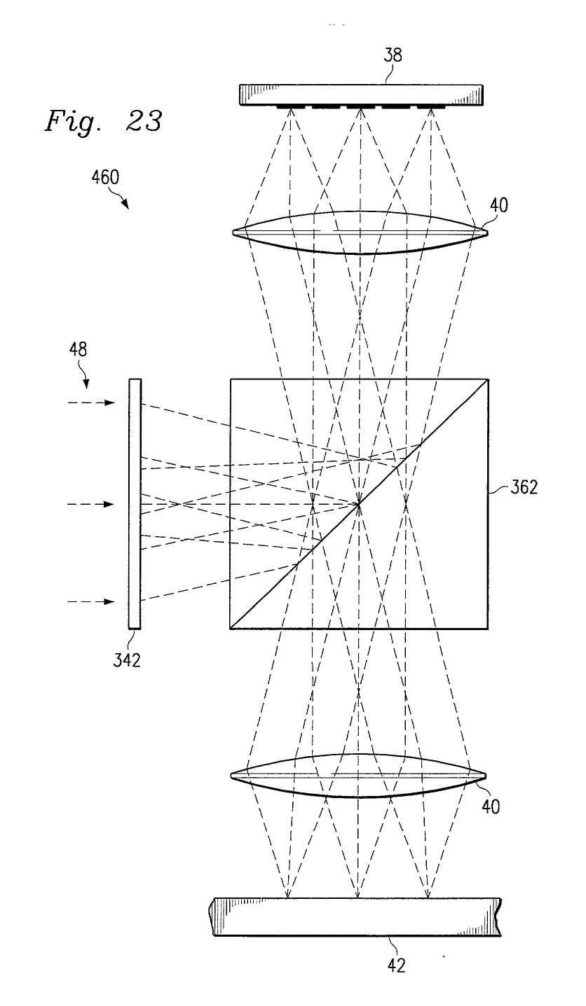

Referring now to FIG. 23, a maskless photolithography system 460 is similar to the system 420 of FIG. 21, except that the image lens 40b is positioned on both sides of the beam splitter 382.

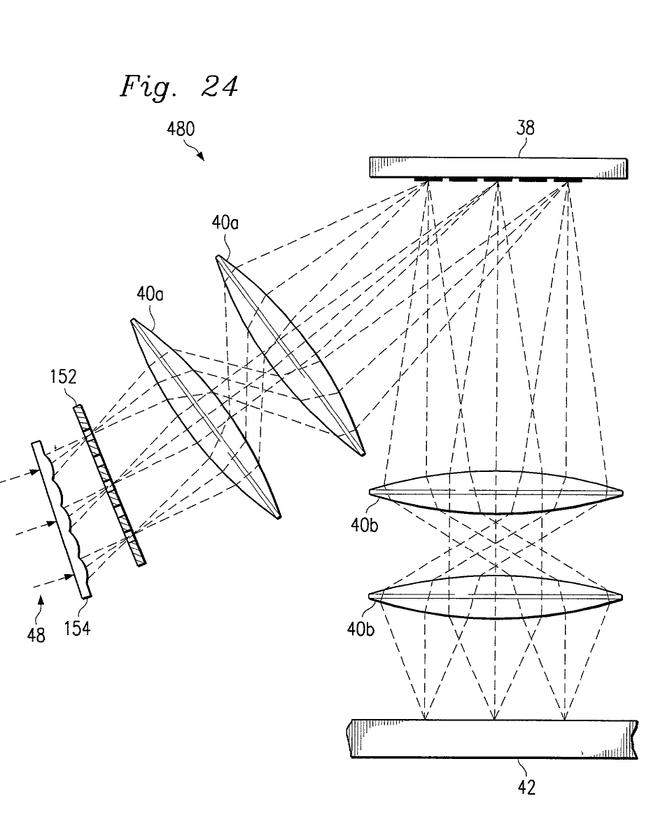

Referring now to FIG. 24, a maskless photolithography system 480 is similar to the system 320 of FIG. 16, except that the pixel panel 38 is a DMD, and the light reflects off the individual micro mirrors of the DMD at a predetermined angle.

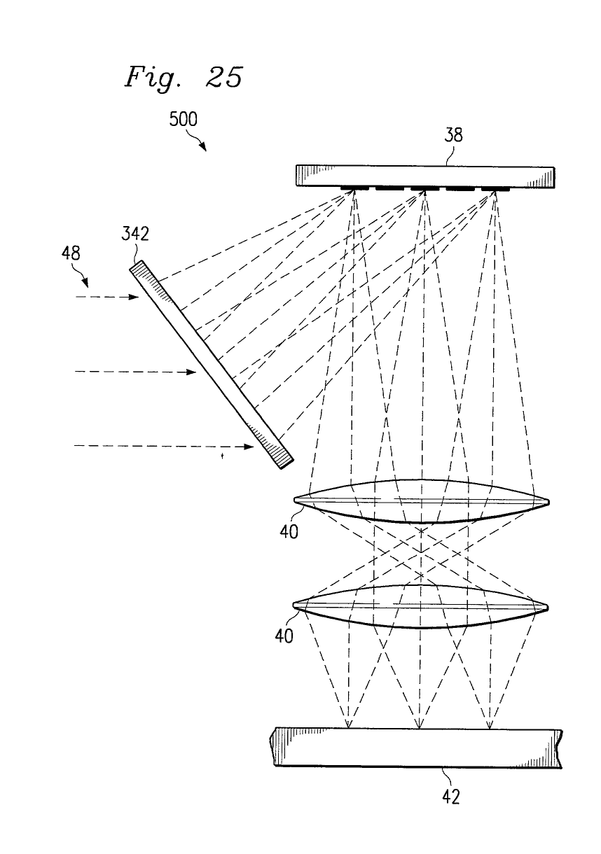

Referring now to FIG. 25, a maskless photolithography system 500 is similar to the system 340 of FIG. 17, except that the pixel panel 38 is a DMD, and the light reflects off the individual micro mirrors of the DMD at a predetermined angle.

Laser Diode Array

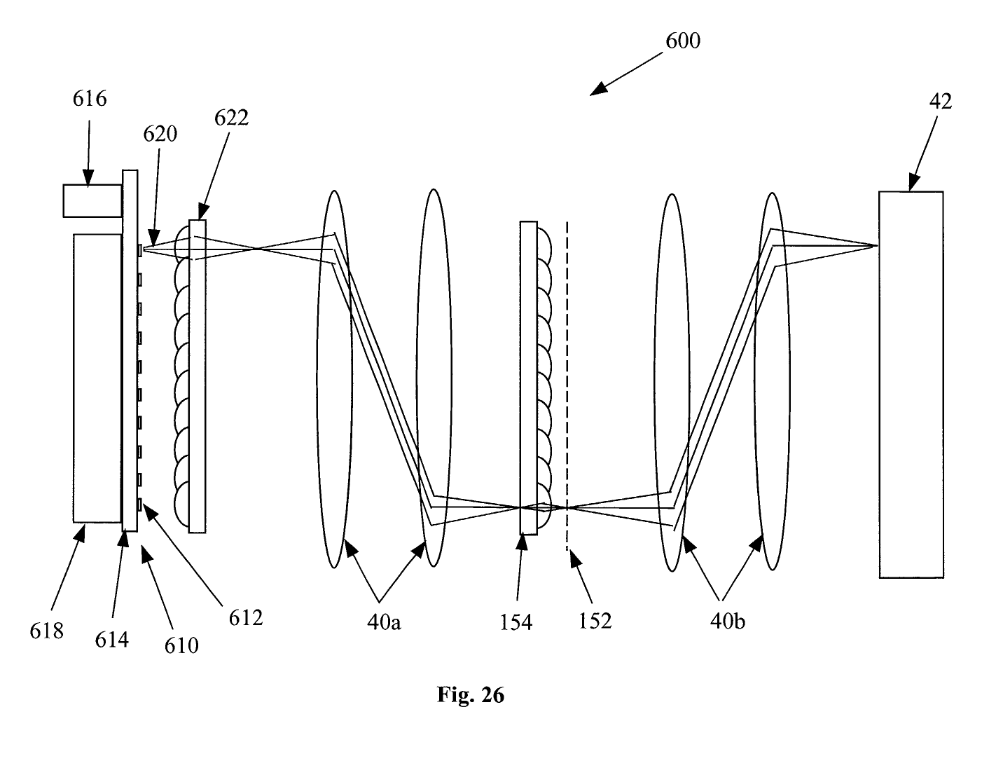

Referring now to FIG. 26, in another embodiment, a photolithography system 600 is similar to that in FIGS. 2 and 11, except that it uses light emitting diodes (“LEDs”) or a laser diode array 610 (described later in greater detail) in place of the light source 32 and the pixel panel 38. The laser diode array 610 includes multiple laser diodes 612 embedded within or mounted upon a substrate 614, and is connected to the computer aided design system 36 through a connector 616. The connector 616 enables the design system 36 to control the laser diode array 610 through the signal line(s) 50. A cooler 618 is operable to prevent excessive heat buildup on the substrate 614.

For purposes of clarity, the operation of a single laser diode 612 from the laser diode array 610 will be discussed. The laser diode 612 projects a laser beam 620, which may be of varying wavelengths and intensity. The wavelength and intensity of the beam 620 may be altered to achieve a desired result. For example, the intensity and/or wavelength of the beam 620 may be altered by regulating the current supplied to the laser diode 612. Such regulation may be exercised on an individual diode basis or multiple laser diodes 612 may be controlled at once.

The shape of the beam 620 projected by the laser diode 612 may be distorted relative to some desired beam shape, and so may require correction. Therefore, the beam 620 may be passed through an aspherical or cylindrical lens array 622 to reshape the beam into the desired shape. For example, the laser diode 612 may produce a beam 620 having an oval shape, instead of a desired circular shape. Therefore, the lens array 622 may be utilized to reshape the oval beam into a circular beam. Once the laser beam 620 is reshaped, it passes through the lens system 40a and then the micro-lens array 154. As described in reference to FIG. 11, the micro-lens array 154 may be a point array, which is a multi-focus device. The beam 620 then passes through the grating 152, which may, as in FIG. 11, take on various forms, be placed in alternate locations, and in some embodiments, may be replaced with another device or not used at all. The beam 620 then passes through a second set of lenses 40b before exposing a discrete site on the substrate 42.

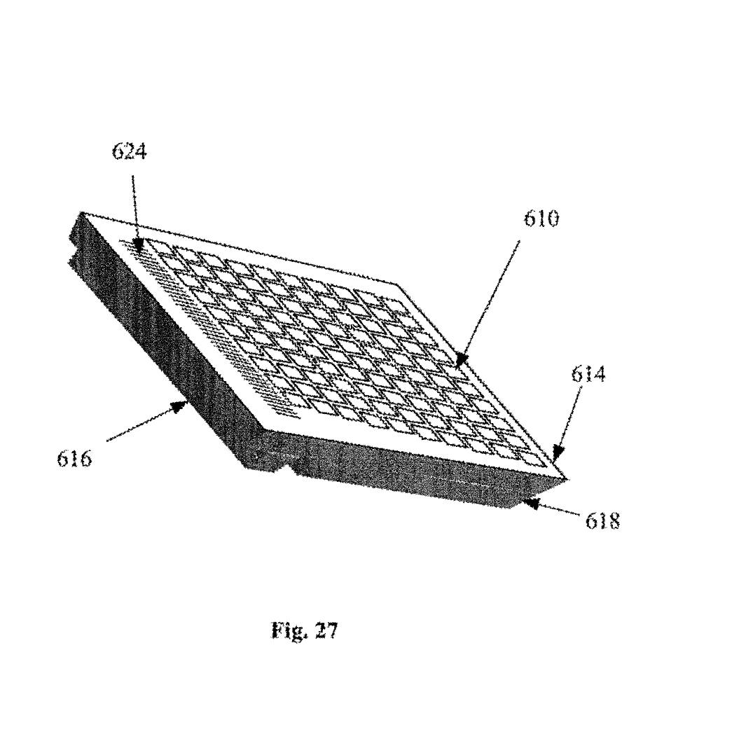

Referring now to FIG. 27, an exemplary laser diode array 610 is illustrated. The laser diode array 610 is embedded in or connectable to a substrate 614, which includes embedded circuitry 624. The circuitry 624, which may include embedded microelectronics and electrical connectors, is operable to provide parallel and/or serial control signals and/or address lines to the laser diode array 610. These control signals may enable the regulation of the wavelength and/or intensity of the laser beam 620, among other things. Connectable to the substrate 614 is a connector 616, which enables the computer aided design system 36 to control the laser diode array 610 through the signal line(s) 50 and the circuitry 624. Proximate to the substrate 614 is a cooler 618, which may be a thermoelectric cooler such as a Peltier cooler. The cooler 618 permits uniform cooling to stabilize the performance of the laser diode array 610. The laser diode array 610 may also include memory (not shown), either embedded into the substrate or made accessible to the array 610 using other common techniques.

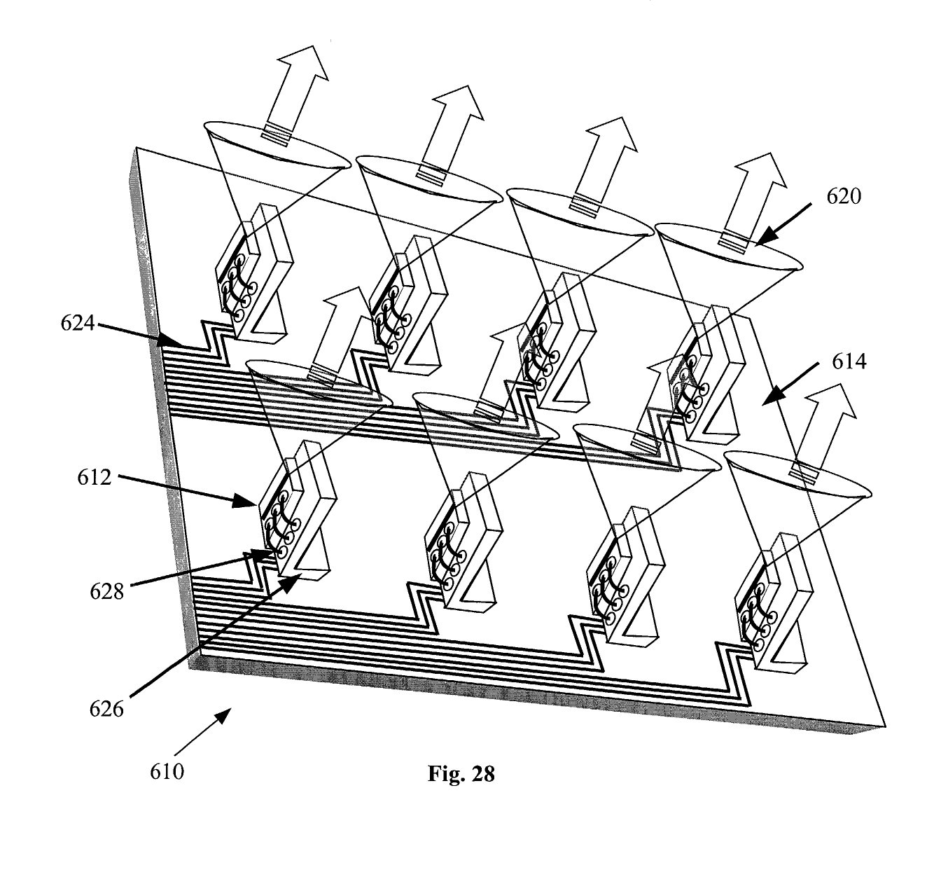

Referring now to FIG. 28, a macrostructure embodiment of the exemplary laser diode array 610 of FIG. 27 is illustrated. The substrate 614 serves as a base for multiple braces 626, which are connected to the substrate 614 and which may be spaced at the millimeter level. For example, the braces 626 may be spaced so that they are separated by one millimeter, although the actual spacing may depend on such factors as the desired functionality of the laser diode array 610 and the construction techniques utilized. In the current embodiment, each brace 626 may serve as a support for one of the laser diodes 612, although in other embodiments each brace 626 may support multiple laser diodes 612. Each laser diode 612 is fastened to one of the braces 626 by wire bonds 628, although other fastening means may be used. A portion of the circuitry 624 is connected to each diode, either directly or indirectly, such as through the braces 626 and the wire bonds 628.

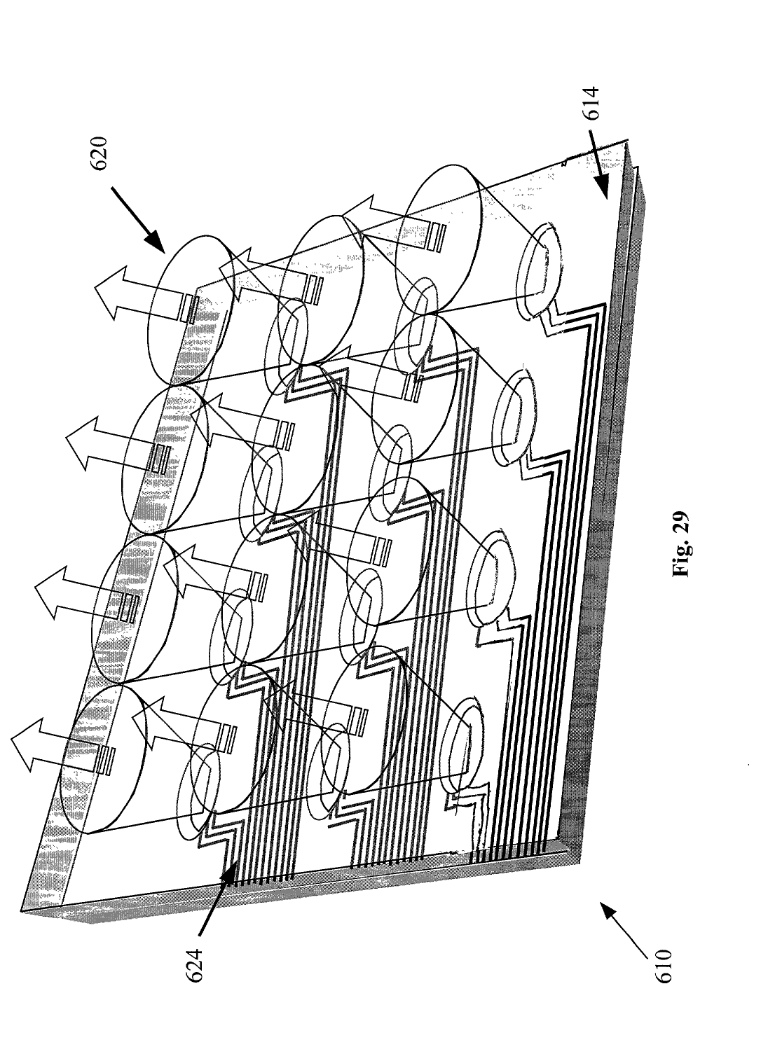

Referring now to FIG. 29, a microstructure embodiment of the exemplary laser diode array 610 of FIG. 27 is illustrated, such as a commercially available vertical cavity surface emitting laser (“VCSEL”) diode array. The individual laser diodes 612 may be integrated into the substrate 614 in the VCSEL diode array and may be spaced at the micrometer level. For example, the laser diodes 612 are commonly spaced from one to ten micrometers apart, although greater or lesser distances may be appropriate depending on the particular functionality desired. Similarly to the macrostructure of FIG. 28, the laser diodes may be connected to a portion of the circuitry 624.

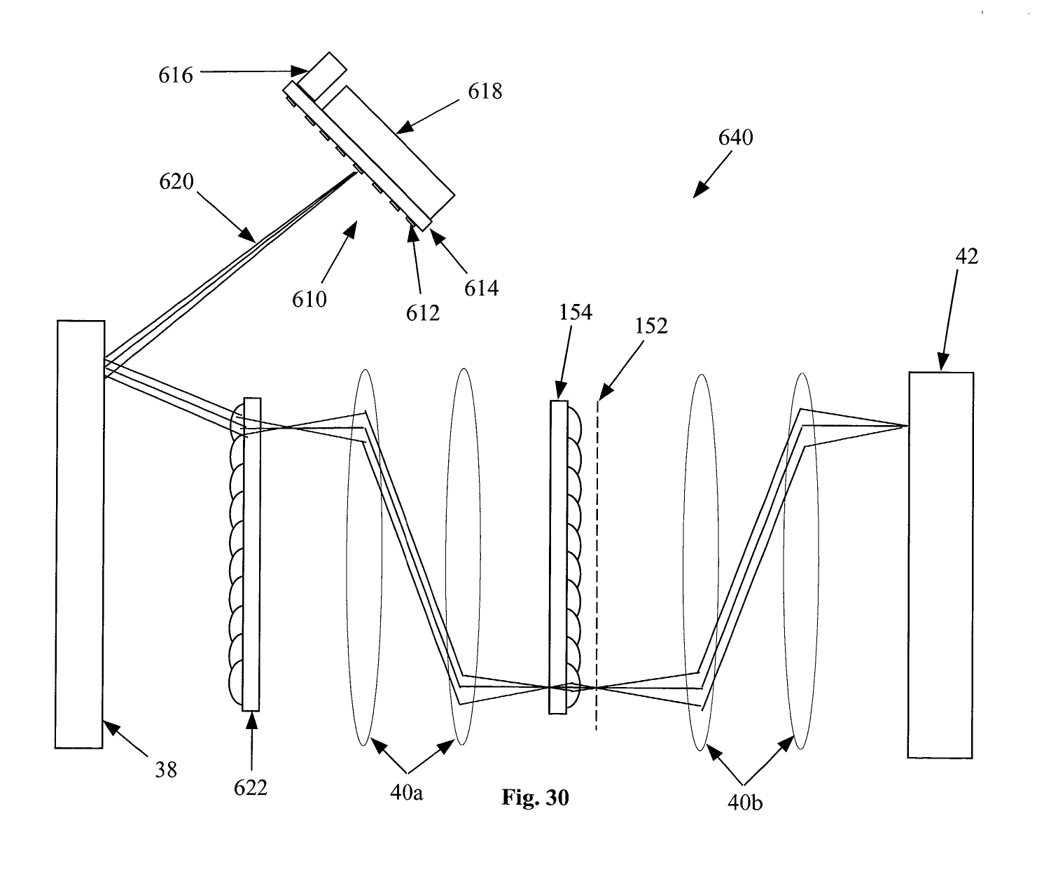

Referring now to FIG. 30, in an alternative embodiment, a maskless photolithography system 640 is similar to the system 600 of FIG. 26, except that the laser diode array 610 serves as a light source for a pixel panel 38, such as the pixel panel 38 of FIG. 2.

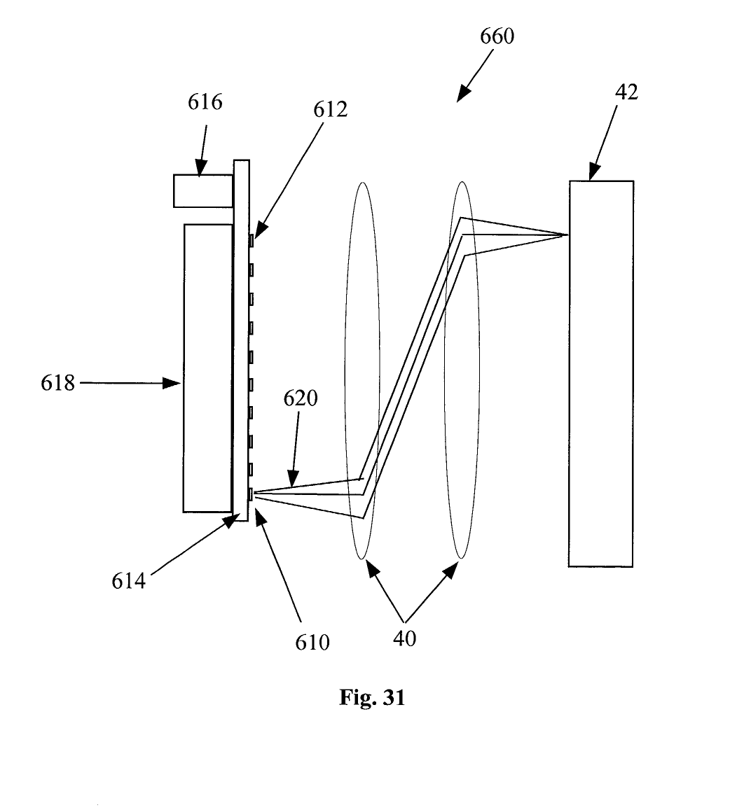

Referring now to FIG. 31, a maskless photolithography system 660 is similar to the system 600 of FIG. 26, except that the laser diode array 610 replaces the grate 152 and/or the micro-lens array 154.

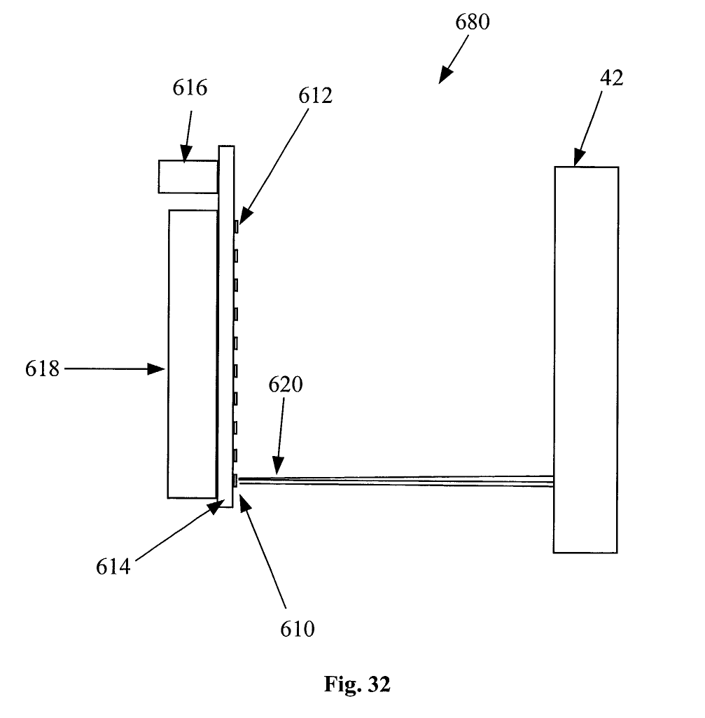

Referring now to FIG. 32, a maskless photolithography system 680 is similar to the system 600 of FIG. 26, except that the laser diode array 610 projects the laser beam 620 directly onto the substrate 42. In alternative embodiments, the laser diode array 610 may project the laser beam 620 onto a variety of subjects. For example, the laser diode array 610 may be used as a head for a thermal printer, enabling the printer to write directly to a thermally sensitive subject.

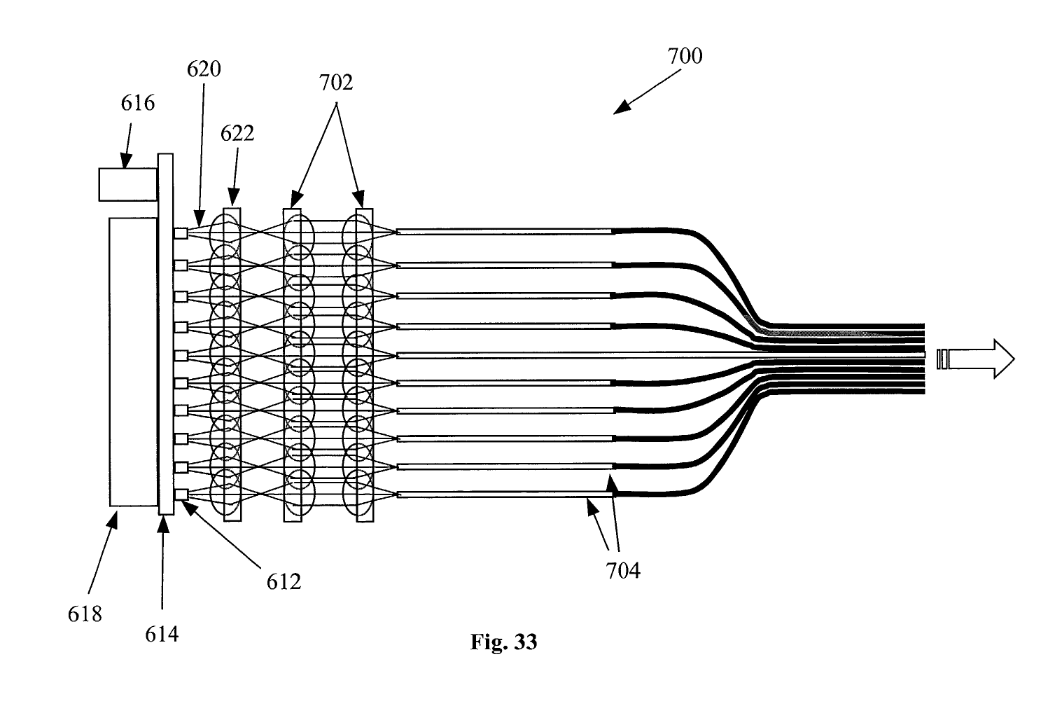

Referring now to FIG. 33, in another alternative embodiment, the laser diode array 610 is utilized as a high power light source 700 by combining the output of multiple laser diodes 612. The laser diodes 612 of the array 610, of which only ten are illustrated for the sake of clarity, project laser beams 620. The beams 620 first pass through the lens array 622 for any desired reshaping of the beams 620 as described above in reference to FIG. 26. The beams 620 then pass through the micro-lens array 702. The micro-lens array 702 provides enhanced coupling between the laser diodes 612 and multiple multimode optic fibers 704. The fibers 704 may be bundled into one or more outputs, which may transfer the light to optics for beam reshaping, decorrelation, and/or the application of other techniques. The output may be used for photolithography, as a laser pump for other lasing media, or in a variety of other applications where such a high power light source may be desired. The present embodiment is shown utilizing the macrostructure of FIG. 28, although other laser diode arrays may be used to implement the high power light source.

One advantage of the laser diode array 610 is that it may be used to replace one or more DMDs or direct projection methods in photolithography. Another advantage is that using the laser diode array may reduce the loss of intensity previously experienced from the light source 32 and reflection imperfections in the pixel panel 38. Additionally, the laser diode array may be focused on a very small point, thereby improving lithography performance.

In yet another embodiment, an array may be fabricated with three primary-color LEDs or laser diodes. The resulting color array may then be used as a projector for holography. In still another embodiment, the LED or laser diode array may be designed so that the array includes a series of incremental wavelengths. The resulting array may then be utilized for spectral analysis. In another embodiment, the array may serve as a lesion-mapping system.

While the invention has been particularly shown and described with reference to the preferred embodiment thereof, it will be understood by those skilled in the art that various changes in form and detail may be made therein without departing from the spirit and scope of the invention. For example, it is within the scope of the present invention that alternate types and/or arrangements of lasers may be used. Furthermore, the order of components such as the lenses 40a, 40b, the micro-lens array 154, and/or the grating 152 may be altered in ways apparent to those skilled in the art. Additionally, the type and number of components may be supplemented, reduced or otherwise altered. For example, in another embodiment, the laser diode array 610 may be combined with the aspherical lens array 622 to form a single component. Therefore, the claims should be interpreted in a broad manner, consistent with the present invention.

What is claimed is:

1. A system for performing digital lithography onto a subject, the system comprising:
a laser diode array for generating a digital pattern, the array including a plurality of laser diodes operable to project at least one laser beam; and
a lens system for directing the digital pattern to the subject.

2. The system of claim 1 wherein the laser diode array is combined with the lens system to form a single unit.

3. The system of claim 1 further including a pixel panel, wherein the laser diode array serves as a light source for the pixel panel.

4. The system of claim 1 further including a lens array for reshaping the at least one beam.

5. The system of claim 4, wherein the laser diode array is combined with the lens array to form a single unit.

6. The system of claim 1 wherein the laser diodes are vertical cavity surface emitting lasers.

7. A method for performing digital lithography onto a subject, the method comprising:
generating a digital pattern using a laser diode array, the array including a plurality of laser diodes operable to project at least one laser beam;
projecting the digital pattern using the at least one beam; and
directing the projected digital pattern to the subject using a lens system.

8. The method of claim 7 further including reshaping the beam using a lens array.

9. A system for projecting a digital pattern onto a subject, the system comprising:
a laser diode array for generating a digital pattern, the array including a plurality of laser diodes; and
a lens system for directing the digital pattern to the subject.

10. The system of claim 9 wherein at least a portion of the subject is thermally sensitive.

11. The system of claim 9 wherein the laser diode array is a color array.

12. The system of claim 11 wherein the color array serves as a holographic projector.

13. The system of claim 9 wherein the system is a lesion-mapping system.

14. The system of claim 9 wherein the subject is a plurality of optical fibers, so that the system is operable as a high power light source.

15. A method for projecting a digital pattern onto a subject, the method comprising:
generating a digital pattern using a laser diode array, the array including a plurality of laser diodes operable to project at least one laser beam;
projecting the digital pattern using the at least one beam; and
directing the projected digital pattern to the subject using a lens system.
